(19) United States
(12) Patent Application Publication
(10) Pub. No.: US 2026/0066684 A1
(43) Pub. Date: Mar. 5, 2026

(54) BATTERY SYSTEM SUPPORTING PLURALITY OF OPERATION MODES ACCORDING TO SOC

(71) Applicant: STANDARD ENERGY INC., Yuseong-gu, Daejeon (KR)

(72) Inventors: Dongyoung LEE, Daejeon (KR); Bugi KIM, Daejeon (KR)

(21) Appl. No.: 19/106,937

(22) PCT Filed: Aug. 24, 2023
(86) PCT No.: PCT/KR2023/012574

§ 371 Date: Feb. 26, 2025

(30) Foreign Application Priority Data
Aug. 26, 2022 (KR) 10-2022-0107295
Nov. 8, 2022 (KR) 10-2022-0147628

(51) Int. Cl. H02J 7/00; H02J 3/32; H02J 9/06

(52) U.S. Cl. CPC H02J 7/933; H02J 3/32; H02J 7/50; H02J 7/82; H02J 9/062; H02J 2105/52; H02J 2207/20

(57) ABSTRACT

The present disclosure relates to a battery system supporting a plurality of operation modes according to the SoC. To this end, the battery system is characterized by comprising: one or more batteries supporting multiple operation modes for power storage or supply according to the state of charge (SoC); and a controller which determines an operation mode of the batteries among the plurality of operation modes according to the power supply state of a grid and the SoC of the batteries, wherein the batteries include a battery supporting an uninterrupted power supply (UPS) mode at an SoC at or below a first standard.

### TECHNICAL FIELD

The following description relates to a battery system supporting a plurality of operation modes based on a state-of-charge (SoC), and more particularly, to a system utilizing a battery capable of supporting both an energy storage system (ESS)/an uninterrupted power supply (UPS) based on a SoC level, and a method for controlling the same.

### BACKGROUND

Use of an ESS is expected to surge as distributed power generation or the like such as renewable energy increases and a demand for power assistance increases. However, the distributed power generation has unstable demand supply characteristics because demand forecasting is relatively difficult and a power generation amount is difficult to control.

In addition, instability in power supply or power outage is caused by a number of factors. Weather (storm, thunderbolt, and lightning) and contact of a tree, a vehicle, an animal, and a balloon may affect electrical equipment, a transmission tower, an electric wire, a power line, and a telephone pole, or a natural disaster such as earthquake or work by human such as landscaping and excavation may also be a factor. In addition, when there is a heat wave or when other power demand is abnormally high, power outage or brownout may occur by a cable, a transformer, and other electrical equipment, which may be a major barrier factor/obstacle to smooth supply of power from a grid to a load.

The instability in the power supply (the power outage) may cause significant human, business, and national damages even though it temporarily occurs in an industrial production plant, a hospital, an emergency center, a data center, a server room, a control tower, an electronic security system, and the like. Stable (battery and) battery management is emerging as an important issue to minimize safety issues such as the fire in the certain data center.

### SUMMARY

### Technical Problem

To solve the above-described problem, an aspect of the present disclosure is to propose a system that utilizes a battery capable of supporting both ESS/UPS based on an SoC level.

Specifically, it is intended to examine requirements of a battery for implementing an ESS that operates to temporarily store energy from a grid and then use the energy when necessary, and an UPS for providing power without interruption in an emergency situation or the like via one battery rather than as separate components, and to propose efficient control method/configuration thereof.

In addition, another aspect of the present disclosure is to propose a battery system and a method for controlling the same for stably supporting a minimum operating voltage/maximum operating voltage of a controller that controls a battery in the battery capable of supporting high-speed charging and discharging.

Problems to be solved by the present disclosure are not limited to the problems mentioned above, and other problems not mentioned will be clearly understood by those skilled in the art to which the present disclosure pertains from a following description.

### Technical Solutions

An aspect of the present disclosure to solve the above-described problem proposes a battery system including at least one battery supporting a plurality of operation modes for power storage or supply, based on an SoC, and a controller that determines an operation mode of the battery among the plurality of operation modes, based on a power supply situation of a grid and the SoC of the battery, wherein the battery includes a battery supporting an uninterrupted power supply (UPS) mode at an SoC equal to or lower than a first reference value.

Further, another aspect of the present disclosure proposes a battery system including at least one battery supporting high-speed charging and high-speed discharging with a current equal to or higher than a second reference value, a controller that manages a state of the battery including a state-of-charge (SoC) of the battery, and a controller voltage assist circuit that maintains a voltage applied to the controller within an operating voltage range of the controller during the high-speed charging or discharging by the current equal to or higher than the second reference value of the battery.

### Advantageous Effects

According to the embodiments of the present disclosure as described above, the ESS that operates to temporarily store the energy from the grid and then use the energy when necessary, and the UPS for providing the power without the interruption in the emergency situation or the like may be implemented via the one battery rather than as the separate components, thereby increasing space efficiency and securing a sufficient reserve ratio of the battery.

In addition, in the battery capable of supporting the high-speed charging and discharging, the minimum operating voltage/maximum operating voltage of the controller that controls the battery may be stably supported without the component for separately introducing external power.

Effects obtainable in the present disclosure are not limited to the effects mentioned above, and other effects not mentioned may be clearly understood by those skilled in the art to which the present disclosure pertains from the following description.

### BRIEF DESCRIPTION OF THE DRAWINGS

FIG. 1 is a diagram for illustrating a concept of an SoC to be used in embodiments according to the present disclosure.

FIG. 2 is a diagram for specifically illustrating a problem in UPS/ESS mode utilization described in FIG. 1.

FIGS. 3 and 4 are diagrams for illustrating a structure when an NaS battery is used as a battery for an ESS.

FIG. 5 is a diagram for illustrating a battery system supporting an UPS/ESS mode according to an embodiment of the present disclosure.

FIG. 6 is a diagram for illustrating an operation mode of a battery according to an embodiment of the present disclosure.

FIG. 7 is a diagram for illustrating a structure of a VIB ESS/UPS according to an embodiment of the present disclosure.

FIGS. 8 to 11 are diagrams for illustrating an operating method when an emergency situation occurs in a battery system according to an embodiment of the present disclosure.

FIG. 12 is a diagram for illustrating a recovery operation when an emergency situation is ended according to an embodiment of the present disclosure.

FIG. 13 is a diagram for illustrating a phenomenon in which charging and discharging of an ESS is performed at a high speed with respect to a specific load.

FIG. 14 conceptually illustrates a case in which a booster circuit is applied in an embodiment of the present disclosure.

FIG. 15 is a conceptual diagram conceptually showing a case of a sudden voltage drop during high power output of a battery.

FIG. 16 is a conceptual diagram conceptually illustrating operation of a booster circuit when a power consumption of an environment in which an ESS is installed is equal to or higher than 0.5 C-rate according to an embodiment of the present disclosure.

FIG. 17 is a conceptual diagram illustrating an ESS assist mode in switching control between an ESS and an UPS according to an embodiment of the present disclosure.

FIG. 18 is a conceptual diagram illustrating an UPS mode 1 in switching control between ESS and UPS modes according to at least one embodiment of the present disclosure.

FIG. 19 is a conceptual diagram illustrating an UPS mode 2 in switching control between ESS and UPS modes according to at least one embodiment of the present disclosure.

FIG. 20 is a conceptual diagram illustrating an UPS mode 3 in switching control between ESS and UPS modes according to at least one embodiment of the present disclosure.

### BEST MODE

Hereinafter, embodiments of the present disclosure will be described in detail with reference to the accompanying drawings such that those skilled in the art to which the present disclosure pertains may easily implement the same. However, the present disclosure may be implemented in various different forms and may not be limited to the embodiments described herein. In addition, to clearly illustrate the present disclosure in the drawings, parts irrelevant to the description are omitted, and similar reference numerals are denoted to similar parts throughout the present document.

Throughout the present document, when a part “includes” a certain component, it means that other components may be further included, rather than excluding other components, unless otherwise stated.

In general, an ESS refers to a device capable of storing energy in various energy storage means and then supplying the stored power back to a grid when necessary. Among such ESSs, an ESS using a battery as the energy storage means is specifically referred to as a battery energy storage system (BESS), but unless otherwise specified in the following description, it is assumed that the ESS is the BESS.

In general, the ESS is composed of the battery, a battery management system (BMS), a power conversion system (PCS), an energy management system (EMS), and the like. The battery may include one or more cells, the plurality of cells may constitute one module, and a plurality of modules may constitute one rack. The ESS constructed as such may be connected to an electrical grid, an electric network, a power grid, and the like to receive power.

In the following description, the battery may include a battery used for the ESS and/or a battery used for an UPS. A state of the corresponding battery may be representatively expressed based on a state-of-charge (SoC), and a charging/discharging speed of the battery may be described based on a charge/discharge rate (C-rate).

First, a charge rate of the battery and/or a discharge rate of the battery may be controlled by the charge/discharge rate (C-rate). The charge/discharge rate (C-rate) refers to a measurement of a current used for charging and/or discharging the battery. For example, discharging a specific battery at 1 C-Rate or 1 C means that a battery having a capacity of 10 Ah (i.e., an amount of electricity when 10 A (ampere) current flows for 1 hour) may discharge 10 A (ampere) for 1 hour from a fully charged state.

When a battery charged at a specific C-Rate is measured, a state-of-charge (SoC) thereof may be identified. When charging the electric vehicle using the ESS, various controls for the charging may be performed by identifying an SoC of the battery inside the ESS, an SoC of the battery inside the electric vehicle, and the like.

In one example, for such control, an SoC-open circuit voltage (OCV) curve may be obtained via the charging and the discharging of the battery. The OCV means a voltage in an open circuit state, and means a result of measuring a battery voltage in a stable state.

Based on the above description, embodiments will be described in detail with reference to the drawings.

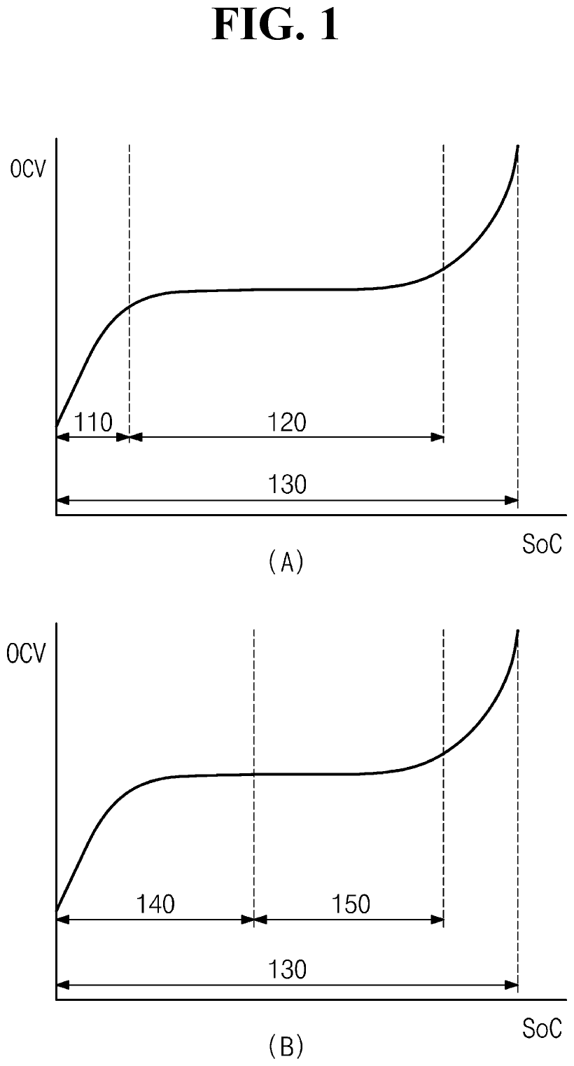

FIG. 1 is a diagram for illustrating a concept of an SoC to be used in embodiments according to the present disclosure.

In general, a manufacturer-provided SoC presents a narrower range than a theoretically available SoC considering safety, battery performance, life, and the like. For example, (A) in FIG. 1 is a diagram illustrating an SoC 120 provided by a manufacturer within a theoretical SoC 130 range in an OCV curve based on an SoC of a specific battery. In the SoC-OCV curve in FIG. 1, a region indicated by reference numeral 110 represents a severe condition region in which there is a fire risk because of low OCV in the case of specific battery such as a lithium ion battery (LIB). Therefore, it is common for the manufacturer to present a region indicated by reference numeral 120 in FIG. 1A as a section of SoC 0% to 100% in consideration of the safety, the battery performance, the life, and the like.

In one example, a range of such manufacturer-provided SoC region may vary depending on a purpose of each application. For example, the battery for the ESS that requires a long lifetime tends to use a narrower SoC range, and the battery for the UPS that requires a lot of instantaneous energy tends to use a wider SoC range.

As described above, to solve the instability in the power supply (the power outage) problem, there has been an attempt to simply combine the UPS with the ESS to use the same, and an UES is also used as a term referring to a battery system used by combining the UPS with the ESS.

However, the reason why it is difficult to simply combine the UPS with the ESS in the related art is that a reserve ratio may be too low when the UPS is required as an emergency situation occurs in a state in which a certain amount or more of energy is used (low SoC) during the use of the ESS.

For example, (B) in FIG. 1 illustrates, in the SoC-OVC curve of the specific battery the same as that in (A) in FIG. 1, a section in which the corresponding battery operates in an UPS mode 140 and a section in which the corresponding battery operates in an ESS mode 150 in a distinguished manner. In the UPS mode 140 as shown in (B) in FIG. 1, a region in which the corresponding battery may actually operate in the UPS mode 140 has no choice but to be limited when excluding the severe condition region 110 as shown in (A) in FIG. 1.

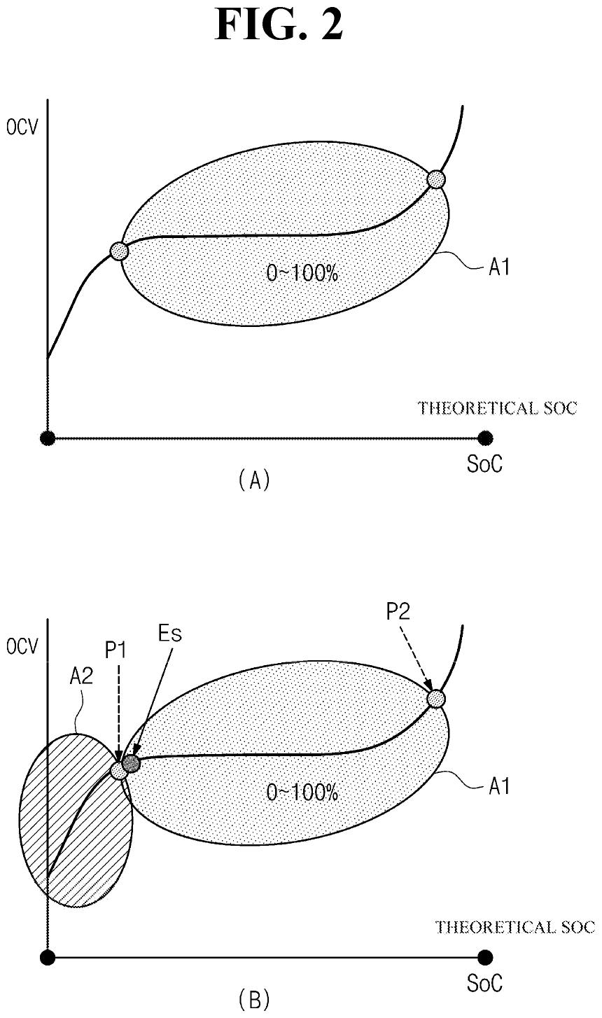

FIG. 2 is a diagram for specifically illustrating a problem in UPS/ESS mode utilization described in FIG. 1.

As described above with reference to FIG. 1, unless otherwise stated in the following description, it is assumed that the SoC refers to the theoretical SoC, that is, an SoC in which a fully discharged state of the battery is set to 0% and a fully charged state of the battery is set to 100%, and a horizontal axis in FIG. 2 represents such theoretical SoC.

On the other hand, the manufacturer reference SoC considering the safety may be relative to each application, and may be referred to as an SoC shown to a user. In FIG. 2, a region A1 may represent a region of operating in the ESS mode. In the example of FIG. 2, the region A1 may correspond to an SoC 0 to 100% section shown to the user. On the other hand, a region A2 represents a region of operating in the UPS.

When the battery used in the ESS/UPS is the LIB, the use of the region A2 may correspond to a fatal area where a fire or the like occurs. Accordingly, at a time point Es when the emergency situation occurs, it is inevitably limited to use the corresponding battery in the UPS mode. Accordingly, in the related art, it is common that the battery used for the ESS and the battery used for the UPS are distinguished from each other, and the battery for the UPS maintains the 100% charged state and is disposed in a separate space.

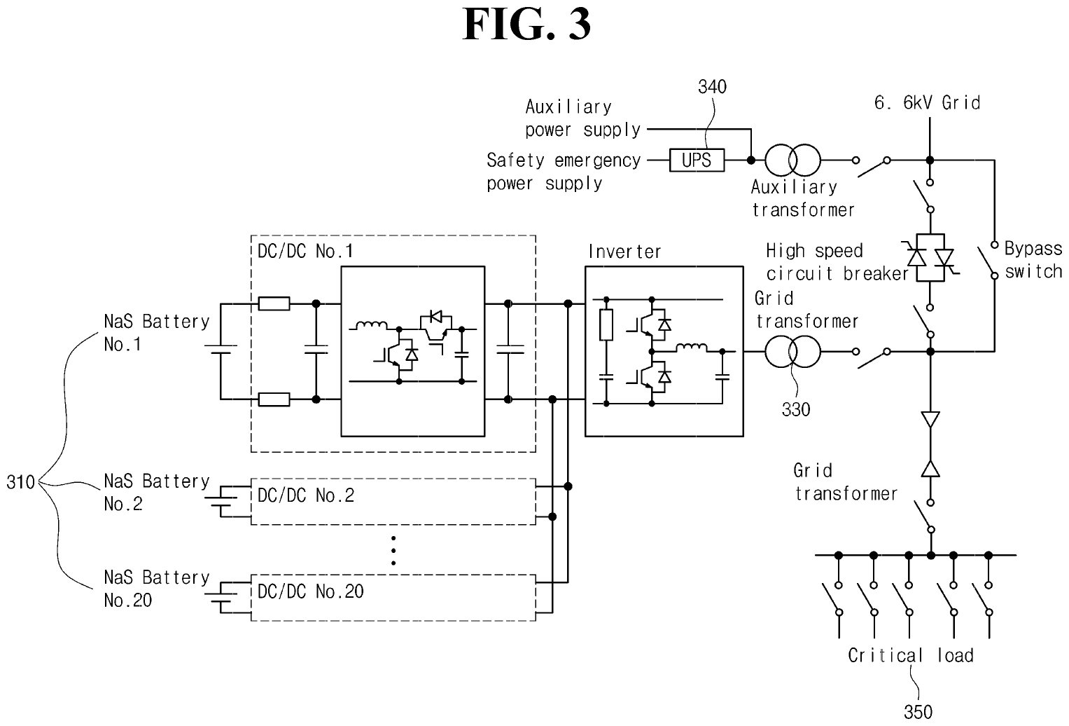

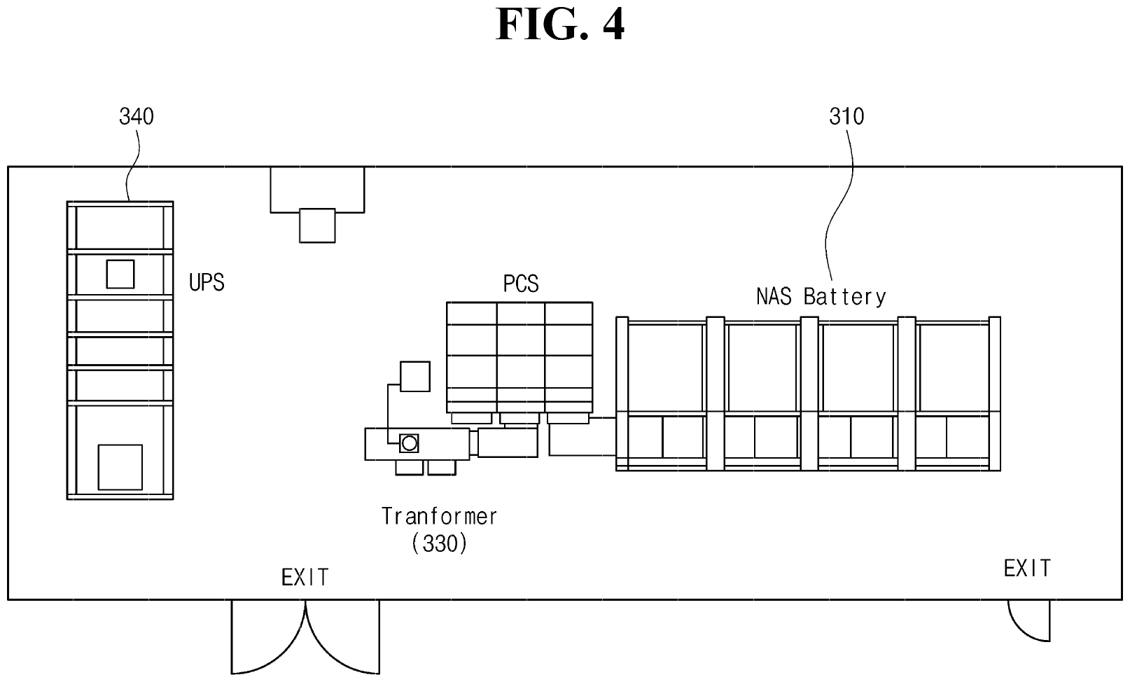

FIGS. 3 and 4 are diagrams for illustrating a structure when an NaS battery is used as a battery for an ESS.

Various types of batteries applicable to the ESS may be used. For example, a lead-acid battery, a lead carbon battery, a sodium sulfur (NAS) battery, a lithium ion battery (LIB), a flow battery, and the like may be used.

FIGS. 3 and 4 illustrate an example in which an NaS battery 310 is used among the above-described batteries. As shown in FIG. 3, a plurality of NaS batteries 310 may be used as the batteries for the ESS to selectively store power provided from a grid via an inverter 320 and a grid transformer 330, or to assist the power of the grid.

In one example, among loads, a load 350 sensitive to the emergency situation such as the power outage or the like needs an emergency power supply means, and FIG. 3 illustrates a form in which an UPS 340 is separately equipped as such an auxiliary power supply means. That is, the load 350 sensitive to the emergency situation includes the grid, the ESS using the NaS battery 310, and the auxiliary power supply source by the separate UPS 340, which may be a factor that hinders space efficiency by occupying a separate physical space as shown in FIG. 4.

Therefore, hereinafter, characteristics of each battery from a point of view of the SoC region, which is the problem when the same battery is used in the distinguished manner in the ESS mode and the UPS mode, will be described, and a battery system using a battery capable of supporting both the ESS mode and the UPS mode will be proposed.

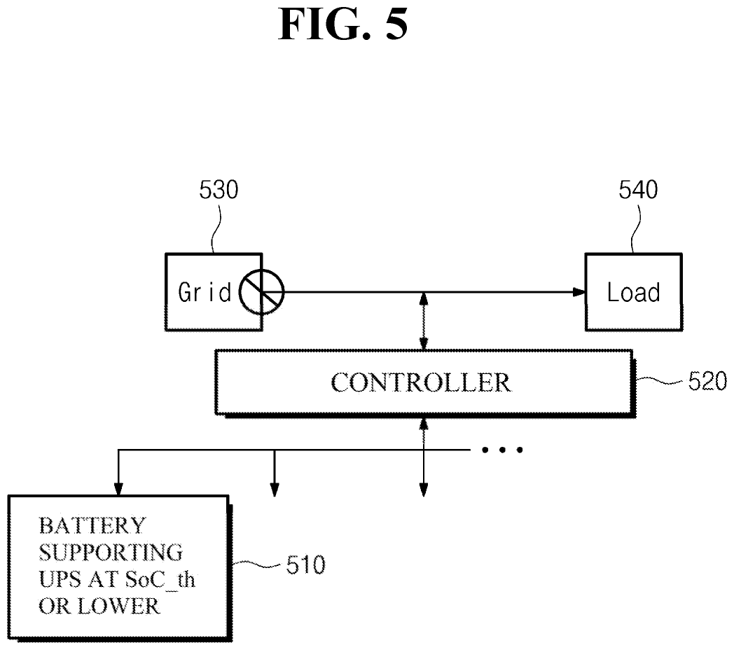

FIG. 5 is a diagram for illustrating a battery system supporting an UPS/ESS mode according to an embodiment of the present disclosure.

First, the battery system according to the present embodiment includes one or more batteries 510 supporting a plurality of operation modes for power storage or supply based on the SoC. In this regard, it is proposed that the battery includes a battery supporting the UPS operation mode at an SoC equal to or lower than a first reference value SoC_th.

In this regard, the SoC is distinguished from the above-described manufacturer reference SoC in consideration of the safety, and is preferable to be based on the above-described theoretical SoC concept in which the fully discharged state of the battery is set to 0% and the fully charged state of the battery is set to 100%. As will be described later, the first reference value SoC_th may correspond to 20%, but the present disclosure may not need to be limited thereto.

When the first reference value SoC_th is determined as the manufacturer reference SoC, it may correspond to 0% of the manufacturer reference SoC.

In one example, the battery system according to the present embodiment may include a controller 520 that determines one of the ESS mode and the UPS mode among the plurality of operation modes based on a power supply situation of a grid 530 and the SoC of the battery 510. The plurality of operation modes may include the ESS operation mode/the UPS operation mode, and may additionally include other operation modes in consideration of safety/utility.

As shown in FIG. 5, the controller 520 is preferably equipped to recognize an emergency situation in which the power supply of the grid 530 is cut off, and is preferably equipped to obtain information such as an amount of power required for a load 540.

In the description of the present document, the ‘emergency situation’ refers to a situation in which the power supply of the grid is cut off because of the power outage in a limited sense. In addition, the ‘emergency situation’ may be interpreted to include abnormal situations including a battery fire, a situation that jeopardizes safety of a passenger, and a situation that does not threaten the safety but makes it difficult to perform a normal situation procedure.

In addition, in a following description, a region operating in the ESS mode among the plurality of operation modes based on the SoC of the battery may be regarded as a ‘normal situation responding region’, and a region operating in the UPS mode among the plurality of operation modes may be regarded as an ‘emergency situation responding region’.

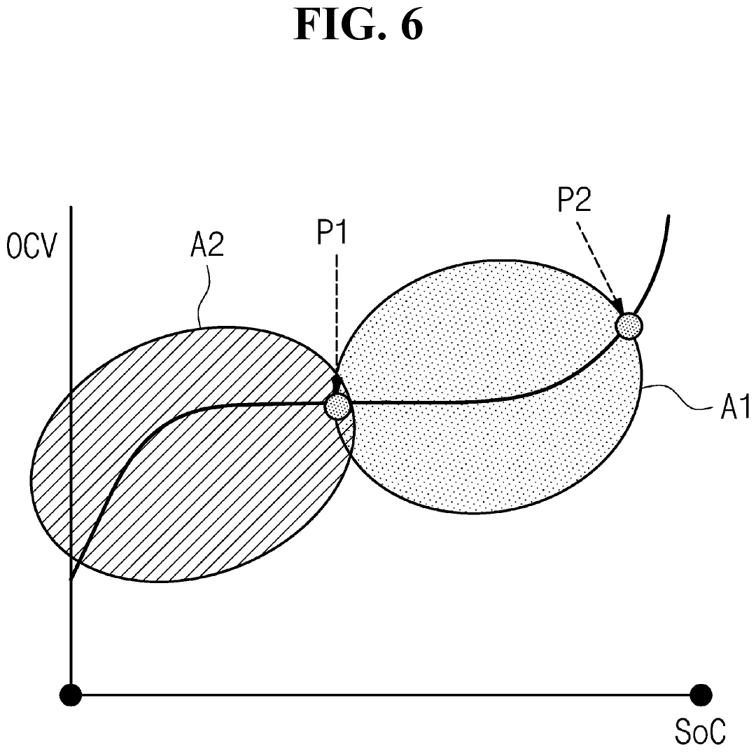

FIG. 6 is a diagram for illustrating an operation mode of a battery according to an embodiment of the present disclosure.

In FIG. 6, as in FIG. 2, the ESS mode region in which the specific battery operates as the ESS is shown as the region A1, and the UPS mode region in which the corresponding battery operates as the UPS is shown as the region A2.

As described above with reference to FIG. 5, the ESS mode of operating as the ESS may correspond to an SoC 0% point P1 and an SoC 100% point P2 shown to the user. In addition, because the battery according to the present embodiment uses a battery that supports the UPS operation mode at the SoC equal to or lower than the first reference value P1, the problem as shown in FIG. 2 may be solved.

As described above, the SoC generally displayed (shown to the user) may mean a range of 20 to 80% of the theoretical SoC. Accordingly, the first reference value P1 may be considered to correspond to 20% based on the theoretical SoC.

In FIG. 6, the UPS region A2 may represent a region operated at the SoC equal to or lower than the first reference value P1, and a preset range (5 to 20% of the theoretical SoC) may be applied to supply power required by a load (in particular, a load sensitive to the power outage) when the electricity supply is stopped as in a case of discharging.

Hereinafter, a battery that satisfies such criteria will be described in detail.

### Battery Comparison

As described above, there are various types of batteries applicable to the ESS, and among such various batteries for the ESS, the LIB, which is currently most popular, and a vanadium ion battery (VIB) proposed by the applicant will be compared with each other and described.

The LIB is attracting attention because it has high energy density and output density, is about three times lighter than an existing lead storage battery, and is able to reduce a space occupying ratio by 50 to 80% with high power density. In addition, the LIB may discharge 1-2% of a charge per month and maintain a long service life, and may be considered to have an advantage of being usable for about 10 years and have 5,000 battery cycles depending on conditions.

However, in the case of LIB, charging and discharging are performed under a basic condition of 0.2 to 0.5 C when operating as the ESS. However, continuous operation thereof is difficult because of heat generation during operation at a high C-rate, and there is a high risk of fire.

In addition, in case of alkaline and lead batteries, they are generally operated at 0.05 C (=20 hours discharge) to avoid a battery capacity degradation (a performance reduction) resulted from the heat generation.

On the other hand, the VIB developed by the applicant refers to a secondary battery that uses vanadium ions as an active material to electrochemically store/release energy. In an existing vanadium-based battery, an active material (e.g., the vanadium ion, H+ cations, water, sulfuric acid, and the like) participating in an electrochemical reaction is forcibly circulated/transferred/stored by a pump or the like operating with an external power and stores/releases electrical energy, whereas in the VIB, an active material in a cell and/or a module performs ion change and movement using an internal electric field, an osmotic pressure, a concentration difference, and the like, and the corresponding active material serves to store/release energy via an electrochemical reaction in the corresponding cell and/or module.

In particular, in the case of VIB, charging and discharging are available at 0.5 to 5 C (MAX 10 C). In addition, because the VIB is operated using a water-soluble electrolyte solution, the VIB is free from the risk of fire and has an advantage of being able to utilize a wide SoC.

For example, in the case of LIB, heat is generated and the battery life is affected during high power output, but in the case of VIB, stable high power output is available. In addition, in the case of LIB, there is a limitation such as 1 C charging and 1 C discharging, but the VIB is able to perform input/output flow control with a high output, and for example, when a power outage occurs in the grid, the VIB ESS is able to assist both the grid and the charger with the high output, so that utilization of the VIB ESS has an advantage of performing very efficient ESS charging/discharging management.

In particular, because there is no risk of fire resulted from overload in the case of VIB, when such VIB is applied to the ESS of the present embodiment, the system of the present disclosure may be preferably applied to various auxiliary facilities while ensuring safety, and thus it may be said that the system is a very effective power supply system. In addition, because safe and efficient energy supply is available when utilizing the VIB ESS, the VIB ESS may be used as a very effective, safe, and eco-friendly energy supply means in realizing energy saving, energy environment, carbon neutrality, and the like.

In the case of LIB, a relatively narrow voltage range (window) is usable because there are an upper limit voltage and a lower limit voltage. Specifically, when the LIB reaches 0V or is in a severely discharged state (a state with a voltage lower than the lower limit voltage), a dendritic material is generated and a short circuit resulted from damage to a separator occurs, so that thermal runaway may occur.

On the other hand, in the case of VIB, there is an upper limit voltage, but there is no lower limit voltage, so that a relatively wide voltage range (window) is usable. That is, even in the 0V or completely discharged state, no special problem may occur, and thus the VIB may operate more flexibly depending on a measurement situation of the plurality of watt-hour meters to be described later.

In addition, in the case of LIB, there is an irreversible reaction (a surface precipitation phenomenon, a solid electrolyte interphase, and a cracking phenomenon) resulted from a phase change when a charge/discharge cycle is repeated, so that a difference in capacity occurs during operation of a predetermined cycle. However, in the case of VIB, there is an advantage that there is no difference in the capacity between an initial capacity and a capacity after operation of the predetermined cycle by using a reversible reaction.

In the case of LIB in connection with the upper limit voltage/the lower limit voltage as described above, use at the actual (theoretical) SoC range equal to or lower than 20% is unavailable, but in the case of VIB, because there is no lower limit voltage, use at the actual (theoretical) SoC range equal to or lower than 20% is available.

Main characteristics of the LIB and the VIB may be summarized as shown in Table 1 below.

TABLE 1

| | LIB | VIB |
|---|---|---|
| Fire risk | High | None |
| Charge/discharge | 0.2-0.5 C | 0.5-5 C (Max 10 C) |
| rate | | |
| Voltage range | Upper limit voltage, | Upper limit voltage |
| | lower limit voltage | present, lower limit |
| | present | voltage X |
| Operation at actual | Unavailable | Available |
| SoC lower than 20% | | |
| Characteristics | Irreversible reaction | Reversible reaction |
| during cycle | because of phase | |
| repetition | change | |

A structure using the VIB introduced as described above will be described as follows.

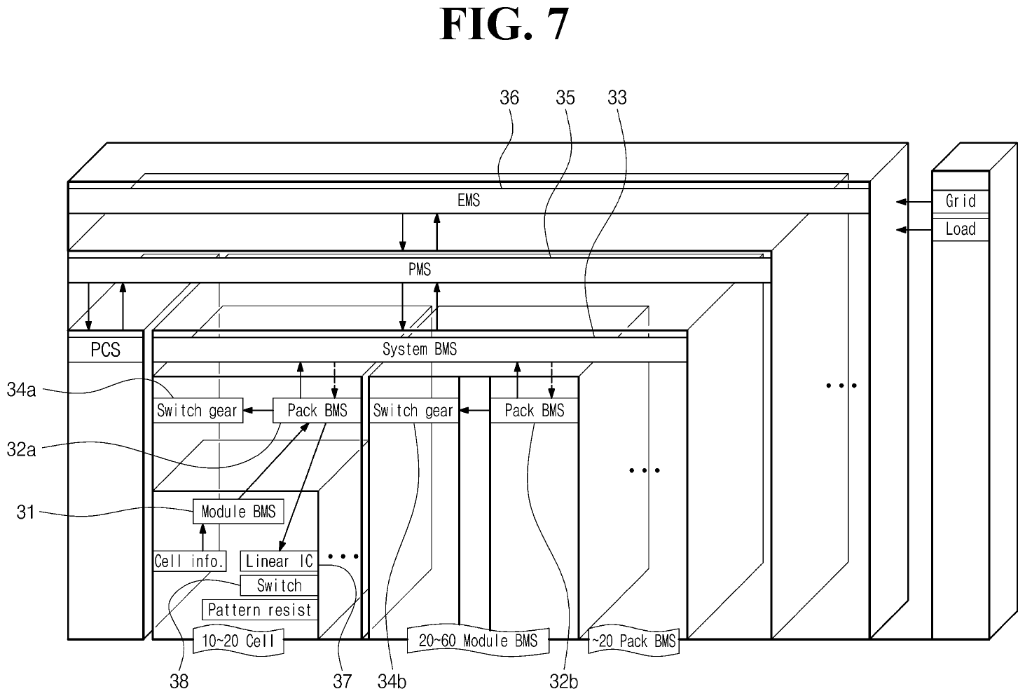

FIG. 7 is a diagram for illustrating a structure of a VIB ESS/UPS according to an embodiment of the present disclosure.

As shown in FIG. 7, the VIB ESS/UPS also includes the components such as the battery, the BMS, the PCS, and the EMS.

Specifically, the battery may be structured starting from the smallest cell unit, 10 to 20 cells may be grouped together to constitute a module, a plurality of modules may constitute a pack, and a plurality of packs may constitute a system level. In response to such structure, the BMS may also have a hierarchical structure of a cell BMS (not shown), a module BMS 31 (level 1), a pack BMS 32 (level 2), and a system BMS 33 (level 3).

Here, each level means an operation level including other control components as well as the above-described BMS. For example, the level 2 may define a control of the above-described pack BMS 32 with a level 1 control stage and a control operation with respect to a switch gear 34, and the level 3 may define a control operation between the system BMS 33 and a PMS 35. Further, a final level 4 may define a control operation between the plurality of PMSs 35 and an EMS 36.

In this regard, the switch gear 34 may control the battery and a power line (a contactor, a precharge, and a fuse), and a linear IC 37 may receive a command from the pack BMS 32 to turn on a switch 38. In this regard, the switch turn-on may mean balancing by a resistance. Here, the resistance may be a pattern resistance in which a copper line is formed in a pattern on a board.

In the above-described structure, the battery may operate in the ESS operation mode or the UPS operation mode by the PCS or the BMSs 31, 32, and 33 at the various levels.

In the structure using the VIB described above, the theoretical SoC may mean ions (divalent and trivalent) having a relatively high energy level among all of the vanadium ions calculated as a ratio.

In the above-described embodiment, the type of battery applied to the ESS/UPS is exemplarily described as the VIB compared to the LIB, but the type of battery applied to the ESS/UPS does not need to be limited to the VIB. For example, in the present document, the ESS/UPS may utilize a vanadium redox battery (VRB), a polysulfide bromide battery (PSB), a zinc-bromine battery (ZBB), and the like.

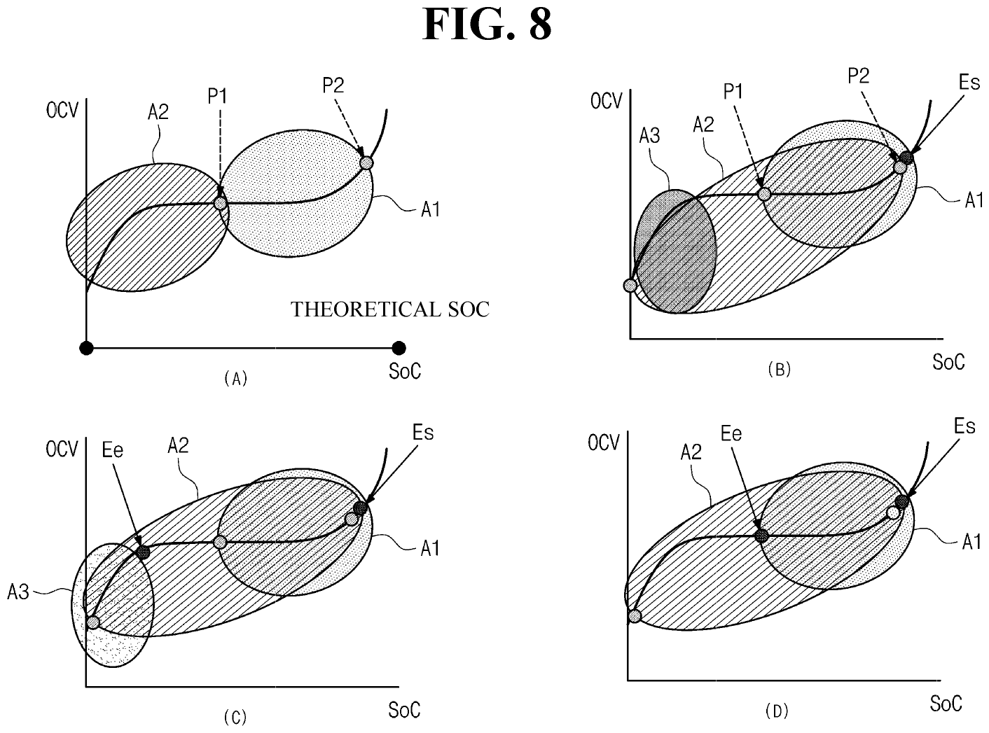

FIGS. 8 to 11 are diagrams for illustrating an operating method when an emergency situation occurs in a battery system according to an embodiment of the present disclosure.

In FIGS. 8 to 11, (A) is a diagram illustrating a concept of using one or more batteries operable in the UPS mode in an SoC region A2 equal to or lower than the first reference value P1 as described above, and using the batteries in the ESS mode and the UPS mode based on a situation recognized by the controller, and is shown for comparison with other situations.

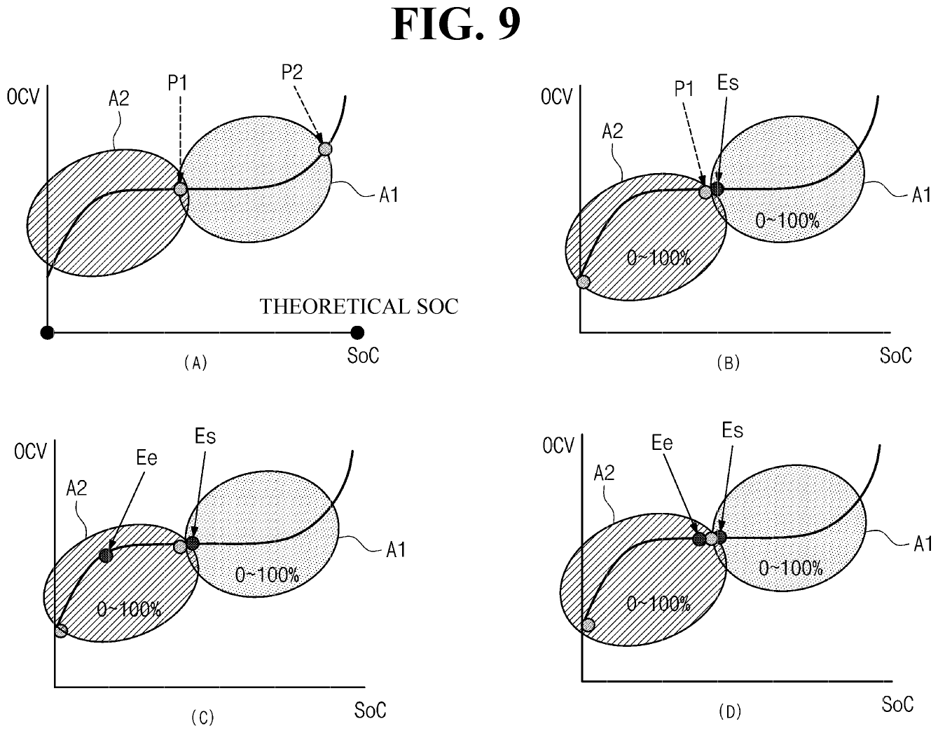

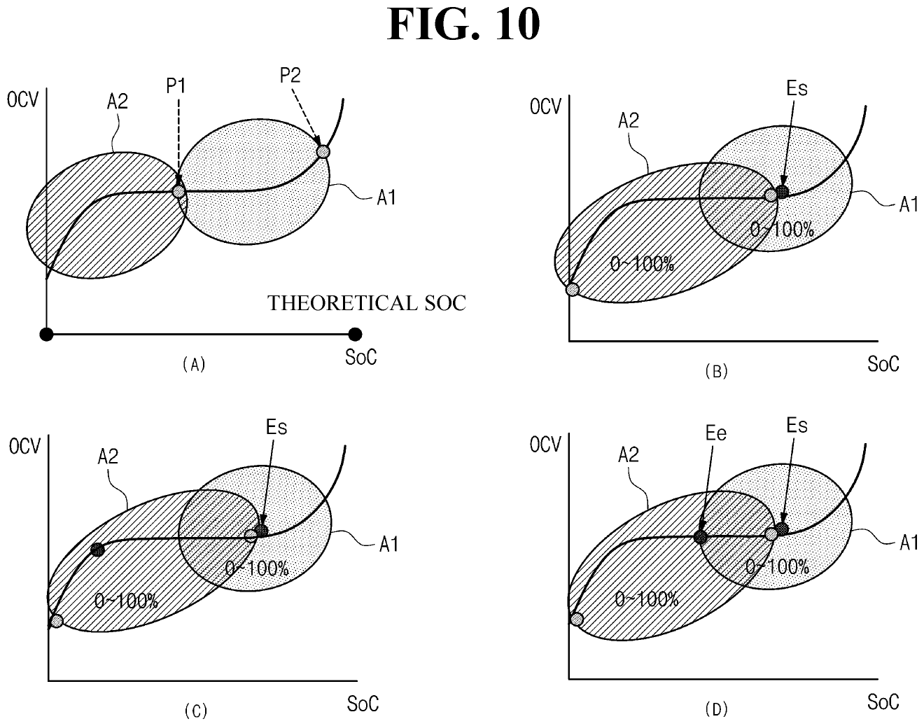

Based on such concept, (B)-(D) in FIG. 8 show a form in which the region A2 of operating in the UPS mode is set to overlap the region A1 of operating in the ESS mode, (B)-(D) in FIG. 9 show a form in which the region A2 of operating in the UPS mode and the region A1 of operating in the ESS mode are set not to overlap each other, and (B)-(D) in FIG. 10 show a form in which the region A2 and the region A1 are set to partially overlap each other.

That is, the battery according to the present embodiment being the battery supporting the UPS mode in the region equal to or lower than the first reference value P1 means that it is a battery capable of using a dangerous region having a risk of fire when using the LIB like a region referred to as A3 in (B) and (C) in FIG. 8 (hereinafter, referred to as the ‘dangerous region A3’) in the UPS mode. However, it does not exclude that the battery may selectively operate in the ESS mode/UPS mode even in the region equal to or higher than the first reference value P1 (that is, the region A1 of operating in the ESS mode).

In addition, in the present embodiment, there may be a plurality of batteries. When the ESS mode operation region A1 and the UPS mode operation region A2 are set to overlap each other as shown in (B) to (D) in FIG. 8, a first group of the plurality of batteries may be operated in the UPS mode and a second group of the plurality of batteries may be operated in the ESS mode.

In addition, as shown in (B) to (D) in FIG. 9, even when the ESS mode operation region A1 and the UPS mode operation region A2 do not overlap each other, the first group having the SoC equal to or lower than the first reference value P1 among the plurality of batteries may be operated in the UPS mode, and the second group having the SoC equal to or higher than the first reference value P2 may be operated in the ESS mode.

In (B) in FIG. 8, a time point at which the emergency situation, such as the power supply of the grid being cut off, occurs is indicated by reference numeral Es. In this case, some batteries may be operated in the UPS mode and the remaining batteries may be operated in the ESS mode to ensure power supply to an important load in case of the emergency situation.

When some batteries are operated in the UPS mode operation region A2 as shown in (B) in FIG. 8, the user may utilize the fact that the batteries are operable in the UPS mode up to a range outside the SoC range (0-100%) provided by the manufacturer, and for example, the user may recognize that the batteries utilize an SoC range (0-300%) which is three times wider based on the SoC range provided by the manufacturer.

In (C) in FIG. 8, a time point at which the emergency situation ends is indicated by reference numeral Ee. When the time point at which the emergency situation ends is before entering the dangerous region A3 as described above, the controller according to the present embodiment may not have to operate the corresponding battery up to the dangerous region A3, and may perform a recovery operation at this time point.

In addition, (D) in FIG. 8 illustrates a case in which the emergency situation ends in the range of the region A1 operable in the ESS mode. As will be described below, the recovery operation may be controlled to be performed at different levels based on an SoC level of the corresponding battery when the emergency situation ends.

On the other hand, (B)-(D) in FIG. 9 illustrate a case in which the emergency situation occurrence time point Es is immediately before reaching the boundary P1 of the region A1 operable in the ESS mode. In this case, the controller may control only essential devices to be operated to minimize power consumption except for power consumption of the essential devices. (C) and (D) in FIG. 9 illustrate a concept in which the emergency situation is controlled to be ended without lowering the SoC of the battery up to the above-described dangerous region A3 via the non-essential device stop of the controller as described above.

On the other hand, (B) to (D) in FIG. 10 illustrate a case in which the region A2 of operating in the UPS mode is set to partially overlap the region A1 of operating in the ESS mode as described above, which may be seen that the region A2 of operating in the UPS mode is expanded up to a current SoC of the battery to maintain the time point at which the emergency situation is ended after dealing with the emergency situation when the emergency situation occurs as described above with reference to FIG. 9 before the dangerous region A3. When the emergency situation occurs (Es) under such settings, as described above with reference to FIG. 9, only the essential devices (e.g., the BMS, the air conditioner, and the like) may be normally operated to correspond to the emergency situation.

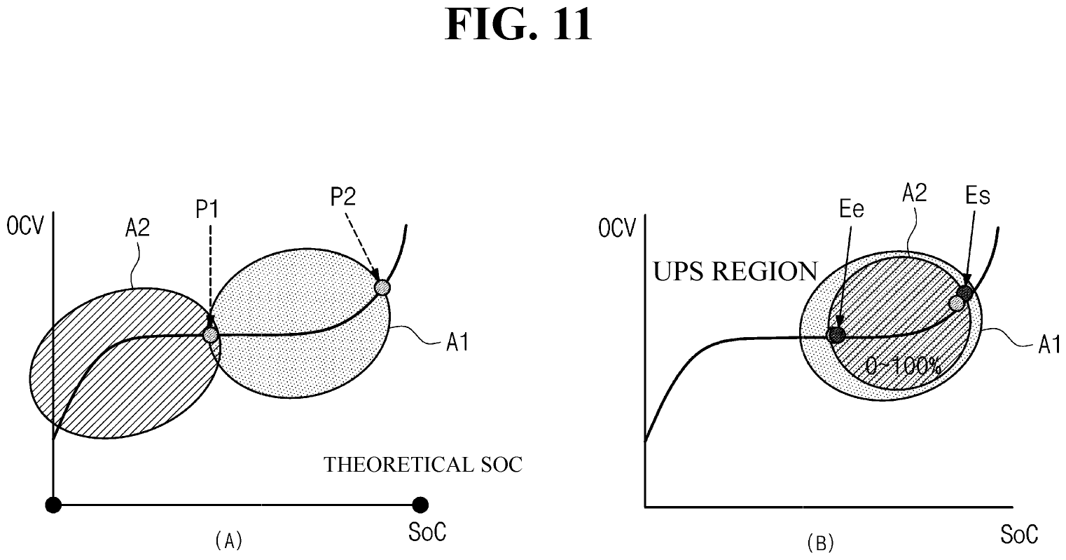

In addition, (B) in FIG. 11 illustrates an example in which the region A2 of operating as the UPS is set to be disposed inside the region A1 of operating as the ESS. Even under such settings, when the emergency situation occurs (Es), the battery may be operated in the UPS mode to control the emergency situation to be ended (Ee) in the region A2 of operating as the UPS.

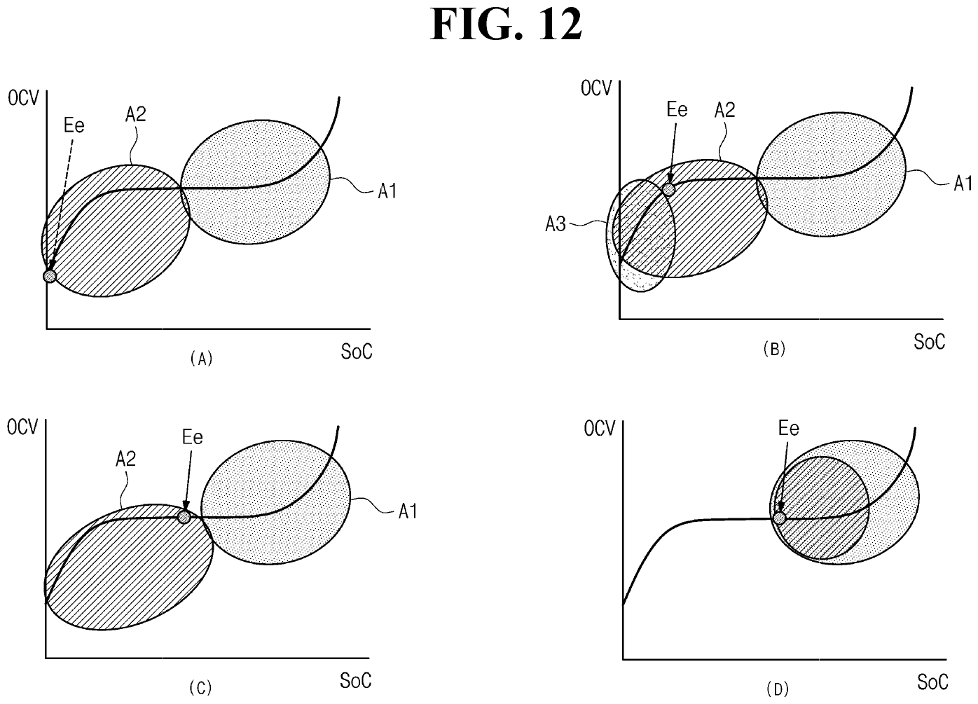

FIG. 12 is a diagram for illustrating a recovery operation when an emergency situation is ended according to an embodiment of the present disclosure.

As described above, when the emergency situation occurs, the controller according to the present embodiment may selectively cut off the power of the non-essential devices based on the SoC level of the battery. Preferably, the controller may be equipped to receive power usage information of the plurality of non-essential devices. To this end, the battery system according to the present embodiment may additionally include a plurality of watt-hour meters such as a watt-hour meter that measures an amount of power used in the ESS/UPS, a watt-hour meter that measures an amount of power used in a load outside the ESS/UPS, and a watt-hour meter used in the charger. Power amount information received from the plurality of watt-hour meters as such may dynamically cope with a situation using a battery capable of high-speed charging and discharging, such as the VIB, and supply power to a necessary load.

In one example, as illustrated in FIG. 12, the controller according to the present embodiment may control the recovery operation of the battery at different levels based on the SoC level of the battery when the emergency situation is ended.

For example, (A) in FIG. 12 illustrates a case in which the end of the emergency situation is performed in a region close to 0% of the SoC (that is, the above-described dangerous region A3). The emergency situation may be substantially ended in a region having a potential difference of about 0.6V via an electrochemical reaction. Accordingly, illustrated is a case in which the controller performs one or more of electrolyte reseparation, electrolyte reconstitution, and recovery cycle operation of the battery to restore the corresponding battery to reach the region A1 of operating in the ESS mode. In this regard, when the VIB is used, rather than performing the ‘electrolyte reseparation’ in which the electrolyte is removed from the battery and then injected again, the ‘electrolyte reconstitution’ in which the electrolyte is reconstituted as an anode/cathode electrolyte again at a level of an intermediate material of the anode electrolyte and the cathode electrolyte may be performed.

In addition, (B) in FIG. 12 illustrates a case in which the end of the emergency does not reach the dangerous region A3, but is performed in the UPS mode operation region A2. Accordingly, the controller may recover the SoC by operating the recovery cycle of the corresponding battery.

In addition, (C) in FIG. 12 illustrates a case in which the end of the emergency situation is performed at the boundary between the UPS mode operation region A2 and the ESS mode operation region A1. Accordingly, the controller may recover the SoC of the corresponding battery by normal cycle operation.

In addition, (D) in FIG. 12 illustrates a case in which the end of the emergency situation is performed in the ESS mode operation region A1. Accordingly, the controller may operate the corresponding battery without the special recovery operation.

In the above-described embodiment, it is proposed that the controller operates one or more batteries in the UPS mode when the emergency situation occurs, and preferably performs the high-speed discharging with a current level equal to or higher than a second reference value to cope with such an emergency situation.

In addition, even in the recovery procedure at the end of the emergency situation, the high-speed charging may be performed with a power level equal to or higher than the second reference value to control a recovery speed of the battery to be high.

As an example, the second reference value may be used based on 0.5 C-Rate, and accordingly, a problem in which the high-speed charging and discharging response is difficult in the LIB-based battery system may be solved.

As another example, the second reference value may be variably selected and applied based on an installation situation of the ESS/UPS within a range of 0.5 C-Rate to 5 C-Rate. For example, the second reference value may be variably applied depending on safety of a place where the ESS/UPS is disposed. In addition, it is preferable to determine an upper limit of the predetermined reference value equal to or lower than 5 C-Rate in consideration of a time during which the ESS is involved in a total time required for charging the electrically driven mobility device such as the electric vehicle.

As another example, the second reference value may be used based on 0.2 C-Rate, which may be utilized by equipping an additional means for responding to the battery usage problem in the above-described dangerous region A3 while applying the LIB-based battery or the like to the ESS/UPS.

As described above, the VIB is representative as a battery supporting a charging/discharging speed equal to or higher than the second reference value, but other batteries are also useable as described above as long as they satisfy the above-described criteria.

However, the present inventor has recognized a problem in which a relatively great cell deviation may occur during the high-speed charging and discharging of the battery and a voltage may drop to an operating voltage of the controller, such as the BMS or lower. A configuration for stably operating the battery system even in such case will be described below.

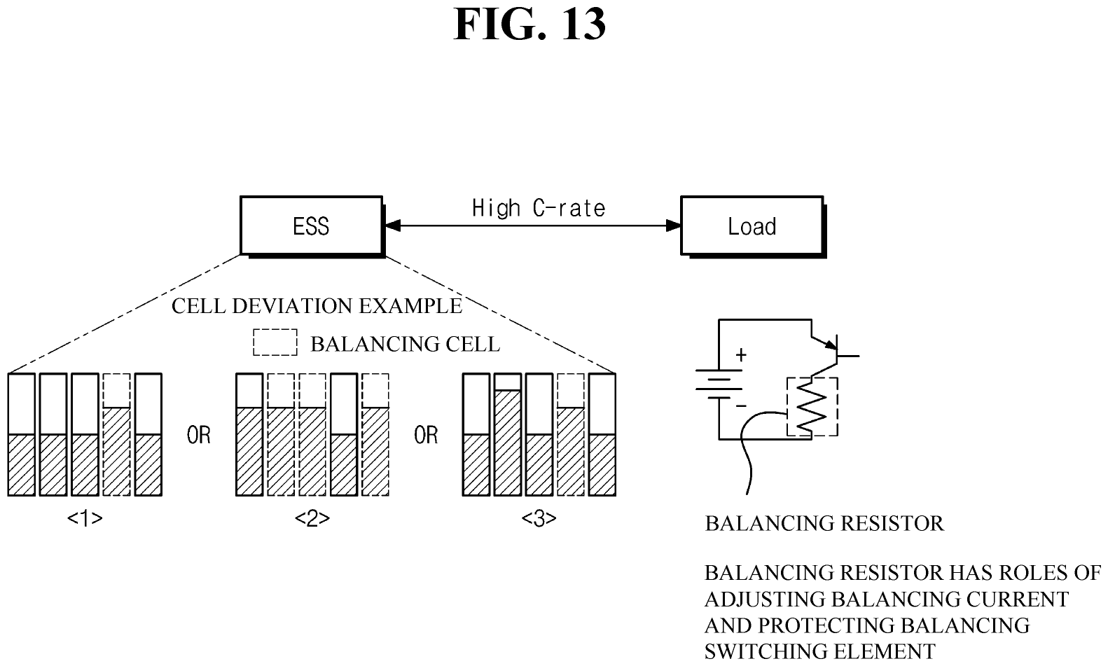

FIG. 13 is a diagram for illustrating a phenomenon in which charging and discharging of an ESS is performed at a high speed with respect to a specific load.

A reference for the high-speed charging and discharging may be determined as a C-Rate equal to or higher than the second reference value as described above. Further, various cell deviations for the cells of the ESS-internal battery are exemplarily illustrated in <1>, <2>, and <3> in FIG. 13.

The present inventors have recognized a problem in which a cell deviation occurrence probability and a deviation voltage increase during the high C-rate charging/discharging. As a solution, an amount of balancing current may be adjusted by pulse width modulation (PWM), and may be controlled by balancing a maximum amount of current during high C-rate operation and balancing a minimum amount of current during low C-rate.

As a result, because the balancing current is flexibly controlled, stable high C rate maintenance is available. For example, when there are many cells in which the cell deviation occurs, PWM control may be performed to balance a specific cell a little more.

There may be various specific balancing schemes, and there may be no limitation thereto. Further, it is important to flexibly adjust the balancing current. In addition, after a resistance value of a balancing current limiting element is maximally reduced at a level capable of protecting a balancing switch element, the balancing current may be controlled via current control using the PWM control.

In addition, the present inventors have also recognized a problem that when the number of over-discharged cells increases during the high C-rate charging/discharging, there may be a concern about stopping of cell monitoring BMS operation.

When the high power discharging is performed during use of battery power as in the existing configuration, stable operation is not available because of fluctuations in input power of the BMS. That is, when the power supply of the BMS is cut off, the ESS power is usually cut off, so that many difficulties occur during the high power discharging. In addition, when an external power source is used as in the existing configuration, there is a problem in that a unit price increases because of addition of components such as multiple connector wires, addition of a manufacturing process required therefor, and addition of an overall cost.

In a preferred embodiment of the present disclosure for solving such problem, it is proposed to construct a booster circuit such that the BMS may operate normally when only a minimum voltage is input. That is, it is suggested that the battery voltage is primarily input, and the input voltage is changed (boosted) to a voltage at which the BMS may operate and provided as the BMS power input.

As a result, the BMS may be stably operated even when the deviation of the battery occurs, and may be stably operated even when multiple over-discharged batteries occur. Further, because only a small number of elements are added to an internal circuit board of the BMS, the unit price increase may be minimized, and addition of a specific process may not be needed.

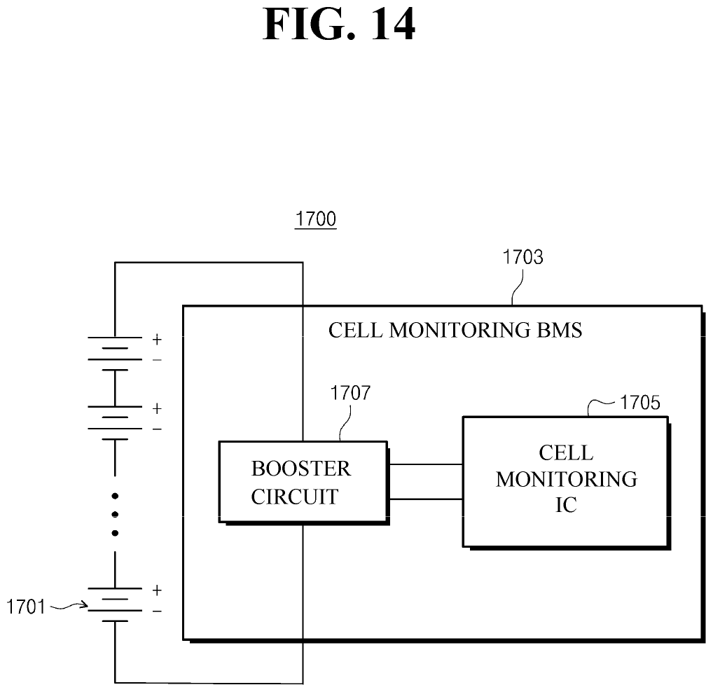

FIG. 14 conceptually illustrates a case in which a booster circuit is applied in an embodiment of the present disclosure.

As a battery management system, FIG. 14 shows a cell monitoring system 1700. A plurality of batteries 1701 are conceptually indicated in the cell monitoring system 1700, and a cell monitoring system (BMS) 1703 is connected thereto. A booster circuit 1707 connected to the batteries 1701 may be present inside the cell monitoring system 1703, and may be controlled by a controller, for example, a cell monitoring integrated circuit (IC) 1705.

The VIB according to an embodiment may use a higher C-rate than the lithium-based battery, and charging and/or discharging may be performed with a high C-rate. In this regard, an abnormal phenomenon such as an overdischarge phenomenon may occur in a specific cell among the batteries. A normal operation of the controller may be required with a minimum voltage to respond to adverse effects of such overdischarged cell. Accordingly, in at least some embodiments of the present disclosure, the booster circuit is further equipped such that the minimum voltage required for the controller, a battery manager, or the like may be provided.

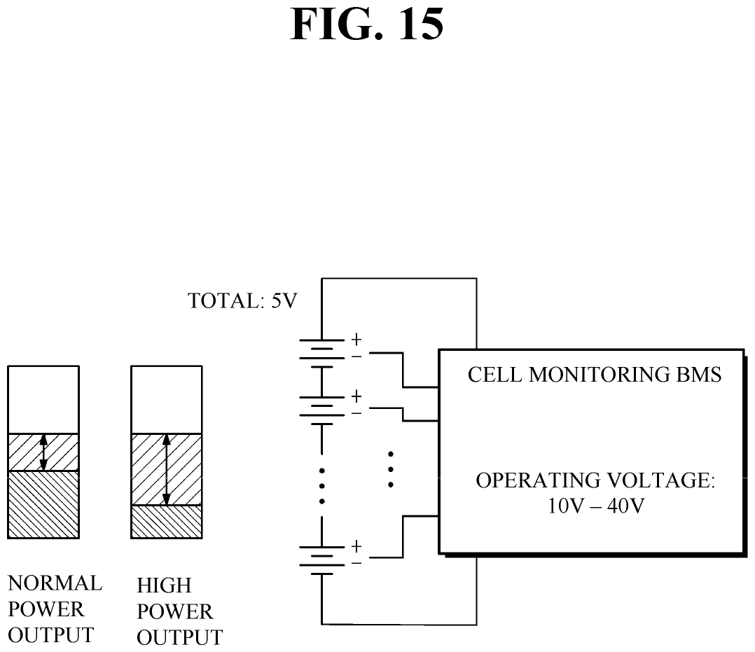

FIG. 15 is a conceptual diagram conceptually showing a case of a sudden voltage drop during high power output of a battery.

A battery management system (BMS: e.g., a module BMS (m.BMS), a cell monitoring BMS 1801, or the like) connected to vanadium-based batteries according to an embodiment may exemplarily have an operating voltage of 10V to 40V.

As described above, during the high power output of the battery, the sudden voltage drop may occur. In the case of BMS operating with the battery power, a BMS operation instability phenomenon may occur because of a battery voltage lower than an operating voltage during the high power output.

Therefore, in an embodiment of the present disclosure, ON/OFF control may be performed based on a situation of the booster circuit. In addition, when in the UPS mode or connected to the high-power system, ON control may be performed on the booster circuit at all times.

In some cases, the voltage applied to the controller such as the BMS during the high-speed charging and discharging of the battery may be too high. In this case, the above-described booster circuit may serve to reduce the voltage of the battery to a voltage within a voltage range of the controller, and in this sense, the booster circuit may be referred to as a ‘controller voltage assist circuit’. However, hereinafter, for convenience of description, a circuit assisting an operating voltage range of the controller will be referred to as the “booster circuit”.

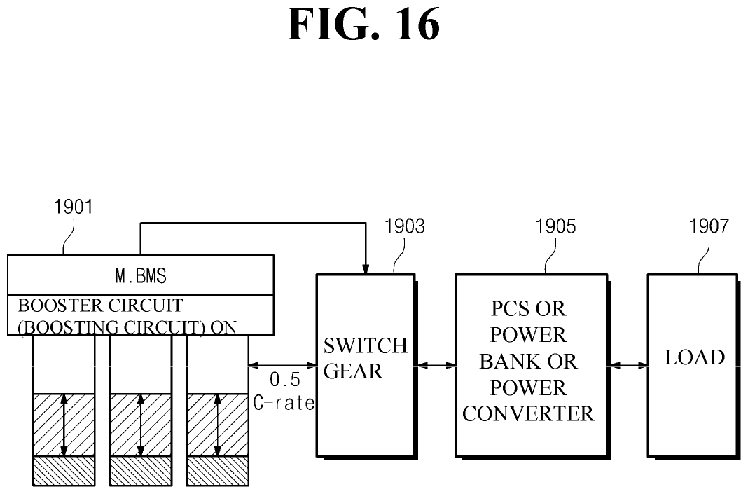

FIG. 16 is a conceptual diagram conceptually illustrating operation of a booster circuit when a power consumption of an environment in which an ESS is installed is equal to or higher than 0.5 C-rate according to an embodiment of the present disclosure.

A BMS 1901 (e.g., a module BMS, a cell monitoring BMS, and the like) may include a booster circuit, a boosting circuit, and the like, and may be connected to a switch gear 1903. The switch gear 1903 may be connected to a power device 1905 such as a power conversion system (PCS), a power bank, a power converter, or the like, and may also be connected to a load 1907.

After performing the corresponding boosting operation in relation to FIGS. 15 and 16 described above, necessary measures may be taken.

For example, when the corresponding BMS operation is able to be temporarily performed by boosting, a shut down operation of the overall system or the ESS may be performed. Alternatively, a charging operation for some cells may be performed to enable the power supply of the corresponding BMS to be quickly re-performed via fast cell charging during the boosted state. As another example, when the electric vehicle charging is being performed, a situation in which the electric vehicle charging is suddenly stopped or suspended may be coped with by continuing the BMS operation with the boosting.

Here, the booster circuit may be controlled and operated in various ways. For example, when the power consumption of the environment in which the ESS is installed is equal to or higher than 0.5 C-rate based on the ESS charging and discharging rate, the booster circuit may be always operated. On the other hand, when the power consumption of the environment in which the ESS is installed is equal to or lower than 0.5 C-rate based on the ESS charging and discharging rate, the booster circuit may be selectively operated.

When a voltage of a module is around +10% of the operating voltage of the module BMS (M.BMS), the booster circuit may be turned on when a module voltage is 10.5V and an M.BMS operating voltage is 10V, and the booster circuit may be turned off when the module voltage is 11.5V and the module BMS operating voltage is 10V.

As another example, when there are n cells (n is variable based on module specifications) whose voltages fall to 1.2V or lower among the cells constituting the module, for example, when voltages of 10 or more cells fall to 1.2V or lower in a case in which 20 cells are one module, the booster circuit may be turned on. As another example, when there are less than 10 cells, the booster circuit may be turned off. When it is determined that a battery remaining life and/or a state of health (SOH) of the module is bad, the booster circuit may be turned on.

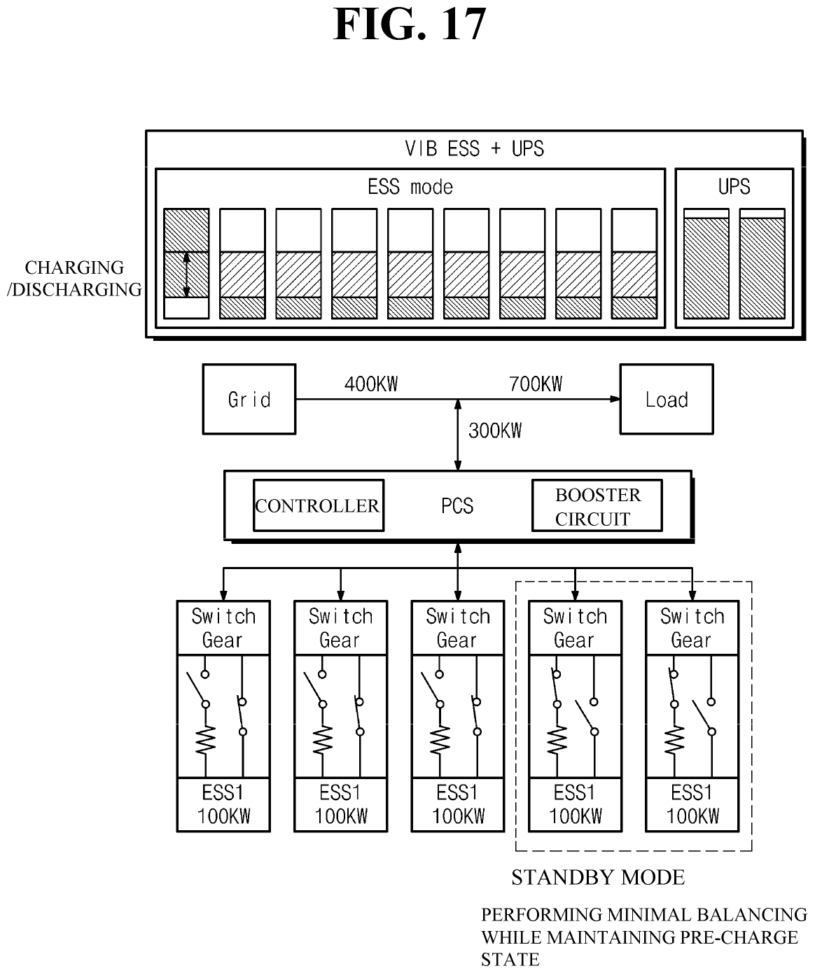

Hereinafter, FIGS. 17 to 20 are diagrams for showing that charging and discharging states are different in a structure (i.e., VIB ESS+UPS) in which a VIB is applied to an ESS and an UPS device and/or function is integrated.

Specifically, FIG. 17 is a conceptual diagram illustrating an ESS assist mode in switching control between an ESS and an UPS according to an embodiment of the present disclosure.

In this regard, the ESS/UPS integrated structure according to an embodiment of the present disclosure is not simply a configuration in which the existing UPS is physically added to the existing ESS. First of all, the VIB, which has completely different electrochemical characteristics from the existing LIB, is utilized, and accordingly, the ESS/UPS integrated structure to which the VIB is applied requires special control and operation.

In one example, the VIB ESS/UPS integrated system of the present embodiment is technically different from the existing ESS to which a redox flow battery (RFB) is applied. In general, the RFB is known to be unsuitable for being coupled to the UPS. The reason is that a reaction speed of the RFB is too low. In other words, for the UPS to be operated in the emergency situation such as the power outage in general and not to disrupt the power supply, the power of the UPS should be supplied instantaneously and rapidly so that the system may operate without substantially losing power. However, the reaction speed of the RFB may be at a level of several seconds and be said to be about 1,000 times lower than that of the VIB, which has a reaction speed at a level of several milliseconds.

Based on the features of the present embodiment, a system using a wide C-rate coverage of the VIB may be provided. With such VIB ESS/UPS integrated configuration, the operation mode of the specific battery may be freely switched between the ESS mode and the UPS mode, thereby contributing to improvement of system safety.

Previously, the ESS and the UPS were built independently, and an ESS dedicated battery pack and an UPS dedicated battery pack were used separately in the operation method. On the other hand, according to the embodiments of the present disclosure, a structure and a control scheme using a battery pack that may be freely switched between the ESS mode and the UPS mode are used.

That is, one of the features of the present disclosure is that the VIB implemented to support the unique ESS/UPS mode switching function without having to separately and independently include the ESS dedicated battery and the UPS dedicated battery is applied and used. In particular, in an embodiment of the present disclosure, a special sensor network (or a monitoring means having a similar function and/or structure) may be implemented and utilized for necessary control.

In the conceptually illustrated configuration, power is supplied from the grid to the load, and the power conversion system (PCS) provides control such as power conversion between the grid and the load. The PCS is associated with a plurality of switch gears and operates to charge and discharge a specific ESS, a battery, a battery pack, and the like inside the ESS system.

In the ESS assist mode operation, environmental variables are given or determined. It is illustratively considered that grid power is 500 kW, an ESS capacity is 100 kW per unit (instantaneous maximum output 500 kW), and a load requirement capacity is 600 kW to 700 kW.

Under such condition, when the operation method of the present embodiment is realized, a control of connecting a specific number of ESS to each other based on the load requirement level occurs. In FIG. 17, ESS 1 to ESS 3 among ESS 1 to 5 may be connected to each other, and ESS 4 to 5 which are not connected to each other may be allowed to standby in a pre-charge state.

As a result, the ESSs may be operated only as much as a required amount of power of the grid, and other ESSs may be used as a preparation for the emergency state. When the corresponding ESS is not in use, a pre-charge mode may be applied, and in this case, natural cell balancing between the battery packs may also be maintained.

In this regard, activation of the pre-charge mode according to the present embodiment has another advantage. In the case of LIB, it is preferable that charging/discharging connection is cut off for the corresponding LIB in the ESS with 0V (volts), that is, the LIB in a completely discharged state, but this is not necessary in the case of VIB with 0V. In other words, when the VIB with 0V is pre-charged by activating the pre-charge mode of the present embodiment, a situation in which the VIB may be reused may be created. This may be considered in relation to the performing of one or more of the electrolyte reconstitution and the recovery cycle operation as described above.

In one ESS according to the present embodiment, the multiple VIBs may be mounted by being coupled to each other in a form of the cell, the pack, the module, or the like. Necessary measurement and control may be performed such that both charging and discharging may be performed together or selectively for the corresponding VIBs. Similarly, a plurality of such ESSs may be connected to each other to operate together or selectively via the necessary measurement and control.

In this regard, the pre-charge operation may be performed on some VIBs in one ESS, may be performed on some ESSs among the multiple EESs, or may be performed on a combination thereof. The pre-charge may mean charging the corresponding VIBs and/or ESSs in advance. In this regard, a time point at which the pre-charging is required, a controlled amount of charge, a time of charging to be performed, and the like may be provided via various measurements and controls or may be customized based on a required power situation. The following description will provide illustrative examples.

Referring back to FIG. 17, the necessary control in the ESS/UPS integrated system may be performed by the controller. The controller is conceptually indicated as one component, and is exemplarily presented to be implemented inside the PCS. However, the controller itself may be implemented as a separate component outside the PCS, or may be integrated into another component of the ESS. In addition, control functions may be equipped in a plurality of components instead of one component in a divided manner. As an example, the control functions may be applied to a specific switch gear, or the functions necessary for the control may be applied to several switch gears in a divided manner.

Further, referring to FIG. 17, the boosting required in the ESS/UPS integrated system may be performed by the booster circuit. The corresponding booster circuit is conceptually indicated as one component, and is exemplarily presented to be implemented inside the PCS. However, the booster circuit itself may be implemented as a separate component outside the PCS, or may be integrated into another component of the ESS. In addition, the boosting functions may be equipped in a plurality of components instead of one component in a divided manner. As an example, the boosting functions may be applied to a specific switch gear, or functions necessary for the boosting may be applied to several switch gears in a divided manner.

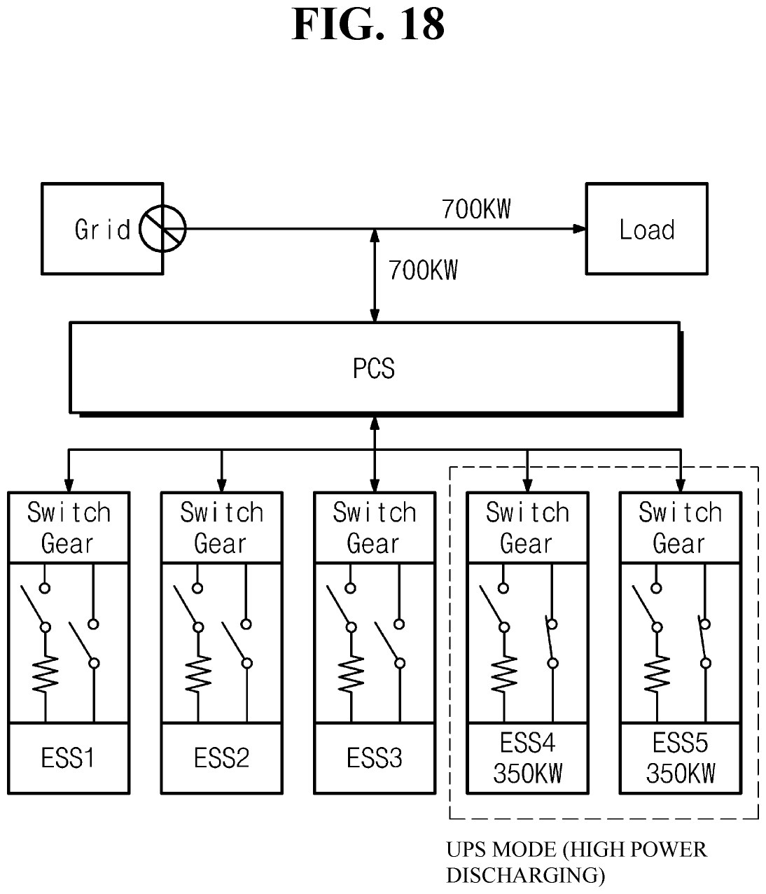

Hereinafter, some operations of the UPS mode in the switching control between the ESS and the UPS will be described with reference to FIG. 18.

FIG. 18 is a conceptual diagram illustrating an UPS mode 1 in switching control between ESS and UPS modes according to at least one embodiment of the present disclosure.

In operation of the UPS mode 1, environmental variables are given or determined. It is illustratively considered that the grid power is in a black out state, the ESS capacity is 100 kW per unit (instantaneous maximum output 500 kW), and the load required capacity is 600 kW to 700 kW.

In this case, that is, in the case of grid power cut-off situation, the ESSs (the ESS 4 and the ESS 5) in the standby mode in the example of FIG. 17 may be connected and controlled to perform power assistance for a time during which the system is restored. The power connection may be cut off until power recovery is performed for the ESSs (the ESS 1 to 3) that have been being discharged. When all of the ESSs that have been being discharged are connected, the power transmitted to the grid is reduced. Therefore, the present embodiment is a scheme of control for transmitting even a little more power of the ESSs (the ESS 4 and 5) operating in the UPS mode 1 to the grid.

As a result, system stabilization is available until the grid is recovered with the instantaneous high power assist of the ESSs in the standby state. FIG. 18 exemplarily shows that the ESS 4 and the ESS 5 operating in the UPS mode 1, for example, support the required power (700 kW) of the load until the grid is stabilized by assisting 350 kW with the high power output.

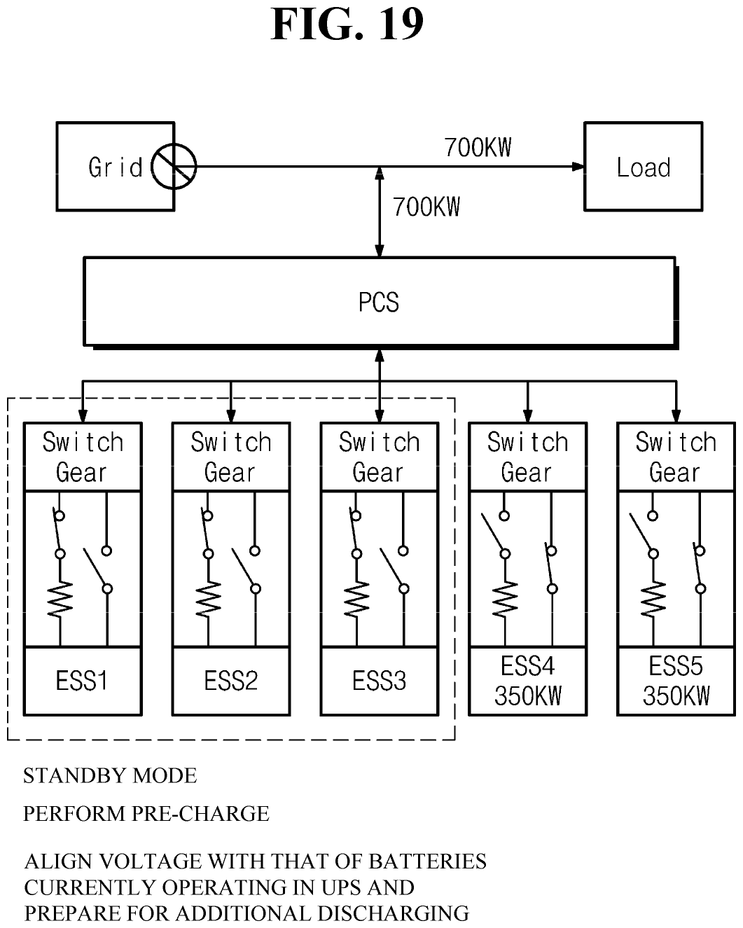

FIG. 19 is a conceptual diagram illustrating an UPS mode 2 in switching control between ESS and UPS modes according to at least one embodiment of the present disclosure.

In operation in the UPS mode 2, environmental variables are given or determined. It is illustratively considered that the grid power is in the black out state, but a recovery delay occurs, the ESS capacity is 100 kW per unit (instantaneous maximum output 500 kW), and the load required capacity is 600 kW to 700 kW.

In this case, a pre-charge connection is performed when a difference between a capacity of an ESS outputting high power in the UPS mode 2 and a capacity of an ESS that was discharged before is equal to or smaller than a threshold value.

For example, other than the ESS 4 and the ESS 5 that are outputting the high power based on the UPS mode 1 in FIG. 18, after the ESS mode discharging in FIG. 17, the ESS 1 to 3 may cut off the power connection as in the example of FIG. 18, and then, when a difference in capacity from the ESS 4 and 5 operating in the UPS mode is equal to or smaller than the threshold value, may perform the pre-charge connection as shown in FIG. 19 to align the voltage thereof with that of the ESS 4 and 5, which are currently operating in the UPS mode.

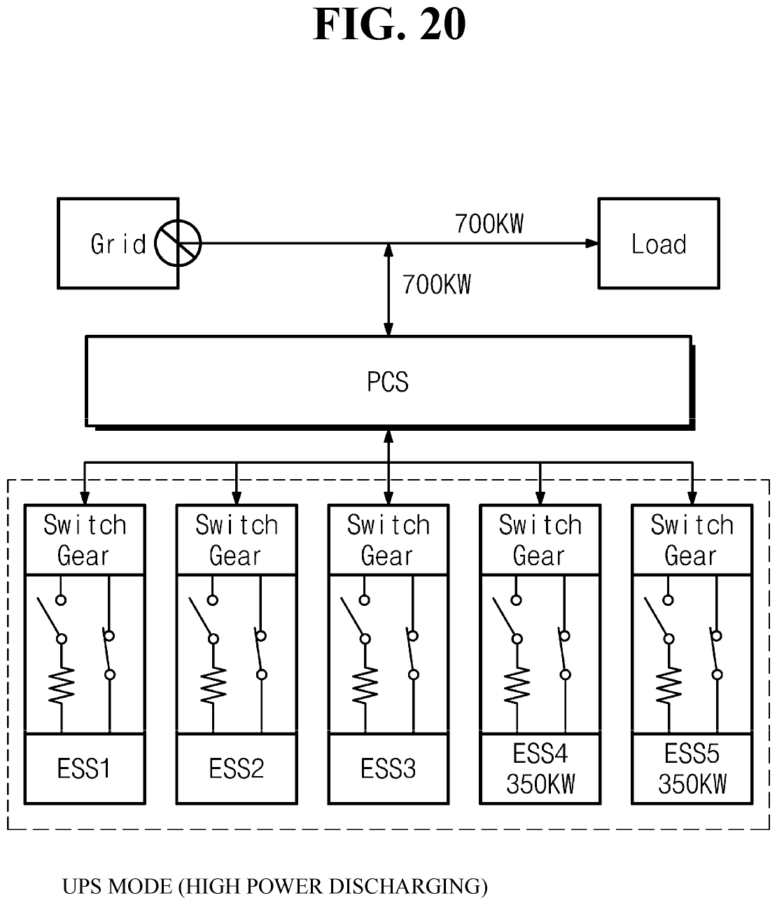

FIG. 20 is a conceptual diagram illustrating an UPS mode 3 in switching control between ESS and UPS modes according to at least one embodiment of the present disclosure.

When the grid power recovery is not performed, as described above with reference to FIG. 19, maximum power supply may be performed using all of the ESSs including the ESS 1 to 3, which have recovered the voltage via the pre-charge, in the form of UPS.

As a result, even in a situation in which the grid power recovery is delayed, a system maintenance time may be maximized.

Referring to FIGS. 17 to 20 described above, in the ESS/UPS integrated system of the present disclosure may operate while switching between the ESS mode and the UPS mode. The pre-charge connection of the ESS will be further described. Here, the names ESS1 to ESS5 may mean respective ESSs, or may mean individual batteries, individual cells, a module in which a plurality of batteries are grouped, and the like.

The reason for performing the pre-charge connection of the ESSs to be switched to the UPS is to provide power by connecting as many ESSs as necessary for the grid load. In this regard, the ESSs that are not connected perform the pre-charge connection to suppress occurrence of a surge resulted from a voltage difference with the load and to immediately supply power in the emergency situation.

In this regard, the reason for the pre-charge connection is that when the emergency situation does not occur in the state divided into the ESS mode and the UPS mode, because of the continuous supply of the power via the battery being used in the ESS mode, a capacity of the corresponding battery is inevitably lowered. Accordingly, voltages of the ESSs in the UPS mode may be higher than voltages of the ESSs in the ESS mode.

In one example, when the emergency situation occurs, the ESSs in the ESS mode are disconnected and the ESSs being prepared in the UPS mode are connected. Then, as the ESSs are operated in the UPS mode, voltage of the ESSs in the UPS mode gradually aligns with voltage of the remaining ESSs that were used in the ESS mode. When the voltages of the ESSs in the UPS mode and the ESS mode become similar to each other, the pre-charge connection may be performed to equalize the voltage across all of the ESSs.

With respect to the ESS1 to ESS5 of the embodiments in FIGS. 17 to 20 described above, it is assumed that all of them are in a 100% charged state at first, and the power outages occur when the ESS1 to ESS3 in the ESS mode are slowly discharged to be in a 70% charged state.

The ESS1, the ESS2, and the ESS3 end the discharging in the 70% state, and the ESS4 and the ESS5 operate in the UPS mode in the 100% state to slowly discharge from 100%, and, for example, at about 72 to 73%, perform the ESS pre-charge operation on the ESS1, the ESS2, and the ESS3.

In this regard, when the battery and other load are connected to each other, when voltage levels thereof are not matched, an overcurrent (e.g., an inrush current) is instantaneously generated, causing a problem.

Therefore, the reason for the pre-charge connection is not to directly supply the power, but to match the voltage levels of the battery and other load.

Because the voltage of the UPS-mode ESSs is higher, the ESS-mode ESSs may be charged during the pre-charge because of the higher voltage of the UPS-mode ESSs. Conversely, the UPS-mode ESSs experience gradual discharging as a result of the pre-charge.

As understood in FIGS. 17 to 20, the ESS/UPS mode operations of the present embodiment may be selectively switched to be used. For example, the control may be performed to periodically switch the UPS modes 1 to 3. Such decision may be made based on how the grid power situation is sensed, and the switching of the ESS/UPS mode operations may be made based on various power supply and demand states as well as the power outage situation. For example, the pre-charge or charging operation may be performed on the ESS or some of the internal batteries at a late night time when the grid power supply and demand are stable or cheaper.

In the contents and related descriptions of FIGS. 16 to 20 above, monitoring means, devices, sensors, measuring instruments, measuring apparatuses, watt-hour meters, and the like for identifying and comparing various amounts of power may be used, and equipment and technology of wired communication or of wireless communication such as Wi-Fi may be used for transmission and reception of the corresponding power amount information.

The detailed description of the preferred embodiments of the present disclosure disclosed as described above has been provided for those skilled in the art to implement and realize the present disclosure. Although the description has been made with reference to the preferred embodiments of the present disclosure, those skilled in the art will understand that the present disclosure may be variously modified and changed without departing from the scope of the present disclosure. For example, those skilled in the art may use each of the components described in the above-described embodiments in a manner of combining them with each other.

Accordingly, the present disclosure is not intended to be limited to the embodiments described herein, but to give a maximum range consistent with the principles and novel features disclosed herein.

### INDUSTRIAL AVAILABILITY

The battery system according to the embodiments of the present disclosure as described above may be utilized in various fields such as charging of various electrically driven mobility devices, a power system requiring stability of power supply, and the like.

1. A battery system comprising:
at least one battery, wherein each battery supports a plurality of operation modes including both an energy storage system (ESS) mode and an uninterrupted power supply (UPS) mode, based on a state-of-charge (SoC); and
a controller configured to determine an operation mode of the at least one battery, among the plurality of operation modes, based on a power supply situation of a grid and the SoC of the at least one battery,
wherein the at least one battery includes a battery supporting the UPS mode at an SoC equal to or lower than a first reference value.

2. The battery system of claim 1, wherein the SoC is distinguished from a manufacturer reference SoC,
wherein the at least one battery supports SoC values within a range equal to or lower than 0% of the manufacturer reference SoC as an available SoC region.

3. The battery system of claim 2, wherein the first reference value corresponds to 0% of the manufacturer reference SoC.

4. The battery system of claim 1, wherein the first reference value is selected within a range of 5 to 25%.

5. The battery system of claim 1,
wherein the controller is configured to control the at least one battery to be operated in the UPS mode in an emergency situation where power supply of the grid is cut off.

6. The battery system of claim 5, wherein the at least one battery includes a plurality of batteries,
wherein the controller is configured to operate a first group of the plurality of batteries in the UPS mode and operate a second group of the plurality of batteries in the ESS mode in the emergency situation.

7. The battery system of claim 6, wherein the first group of the batteries includes batteries having an SoC equal to or higher than the first reference value.

8. The battery system of claim 1, wherein the at least one battery includes a vanadium ion battery (VIB).

9. The battery system of claim 1, wherein the at least one battery supports high-speed charging and high-speed discharging with a current equal to or higher than a second reference value,
wherein the UPS mode supports the high-speed discharging with the current equal to or higher than the second reference value.

10. The battery system of claim 9, wherein the second reference value corresponds to 0.5 C.

11. The battery system of claim 9, further comprising a controller voltage assist circuit configured to maintain a voltage applied to the controller within an operating voltage range of the controller during the high-speed charging or discharging by the current equal to or higher than the second reference value.

12. The battery system of claim 11, wherein the controller includes a battery management system (BMS),
wherein the controller voltage assist circuit is configured to maintain a voltage applied to the BMS within an operating voltage range of the BMS.

13. The battery system of claim 12, wherein the voltage assist circuit is configured to perform one or more of boosting and decompressing of the voltage input to the BMS by being limited to a case where the at least one battery performs the high-speed charging or the high-speed discharging with the current equal to or higher than the second reference value.

14. The battery system of claim 5, wherein the controller is configured to perform the control by distinguishing an ESS region in which the SoC is equal to or higher than the first reference value from an UPS region in which the SoC is lower than the first reference value, based on a level of the SoC of the at least one battery.

15. The battery system of claim 1, wherein the controller is configured to receive power usage information of a plurality of devices,
wherein the controller is configured to selectively cut off power of the plurality of devices, based on a level of the SoC of the battery and the power usage information of the plurality of devices when an emergency situation occurs.

16. The battery system of claim 5, wherein the controller is configured to control a recovery operation of the at least one battery at different levels based on a level of the SoC of the at least one battery when the emergency situation ends.

17. The battery system of claim 16, wherein the recovery operation of the at least one battery is categorized, based on the level of the SoC of the at least one battery, into:
a first level where at least one of electrolyte reseparation, electrolyte reconstitution, and recovery cycle operation is required;
a second level where the recovery cycle operation is required;
a third level where the recovery is available with normal cycle operation; and
a fourth level where no recovery operation required.

18. The battery system of claim 1, wherein the controller is disposed in a power conversion subsystem (PCS) or a power bank.

19. A battery system comprising:
at least one battery supporting high-speed charging and high-speed discharging with a current equal to or higher than a second reference value;
a controller configured to manage a state of the at least one battery including a state-of-charge (SoC) of the at least one battery; and
a controller voltage assist circuit configured to maintain a voltage applied to the controller within an operating voltage range of the controller during the high-speed charging or discharging by the current equal to or higher than the second reference value of the at least one battery.

20. The battery system of claim 19, wherein the controller includes a battery management system (BMS),
wherein the controller voltage assist circuit is configured to maintain a voltage applied to the BMS within an operating voltage range of the BMS.

21. A method for controlling at least one battery by a battery system, each of the at least one battery supporting a plurality of operation modes including both an energy storage system (ESS) mode and an uninterrupted power supply (UPS) mode, based on a state-of-charge (SoC), the method comprising:
assisting power of a grid in a normal situation response region by temporarily storing energy from the grid and subsequently providing the stored energy; and
determining and operating an operation mode corresponding to an emergency situation response region, among the plurality of operation modes, based on a level of the SoC of the at least one battery when the grid enters an emergency situation,
wherein the at least one battery includes a battery supporting the UPS mode at an SoC equal to or lower than a first reference value.

22. The method of claim 21, wherein the determining and operating of the operation mode corresponding to the emergency situation response region includes:
setting the emergency situation response region based on the SoC of the at least one battery.

23. The method of claim 21, wherein the normal situation response region includes a region where the at least one battery is used in the ESS mode,
wherein the emergency situation response region includes a region where the battery is used in the UPS mode.

24. The method of claim 21, wherein the SoC is distinguished from a manufacturer reference SoC,
wherein the at least one battery supports SoC values within a range equal to or lower than 0% of the manufacturer reference SoC as an available SoC region.

25. The method of claim 21, wherein the at least one battery supports high-speed charging and high-speed discharging with a current equal to or higher than a second reference value,
wherein the UPS mode supports the high-speed discharging with the current equal to or higher than the second reference value.

26. The method of claim 21, further comprising controlling a recovery operation of the at least one battery at different levels based on the level of the SoC of the at least one battery when the emergency situation ends.

27. The method of claim 26, wherein the recovery operation of the at least one battery is categorized, based on the level of the SoC of the at least one battery, into:
a first level where at least one of electrolyte reseparation, electrolyte reconstitution, and recovery cycle operation is required;
a second level where the recovery cycle operation is required;
a third level where the recovery is available with normal cycle operation; and
a fourth level where no recovery operation required.
